(19) United States
(12) Patent Application Publication
(10) Pub. No.: US 2025/0057711 A1
(43) Pub. Date: Feb. 20, 2025

(54) TELESCOPIC INCLINABLE FOOTREST FOR A MOTORIZED WHEELCHAIR

(71) Applicant: NEW LIVE INGENIERE, Betschdorf (FR)

(72) Inventor: Michel OHRUH, Betschdorf (FR)

(21) Appl. No.: 18/723,461

(22) PCT Filed: Oct. 26, 2022
(86) PCT No.: PCT/EP2022/079871

§ 371 Date: Jun. 23, 2024

(30) Foreign Application Priority Data
Dec. 29, 2021 (FR) 2114639
Dec. 29, 2021 (FR) 2114642

(51) Int. Cl. A61G 5/12; A61G 5/04

(52) U.S. Cl. CPC A61G 5/128; A61G 5/04

(57) ABSTRACT

The telescopic inclinable footrest device for a motorized wheelchair includes a frame which pivots the structure of a legrest having a sliding plate. The structure is pivotably mounted so as to pivot between a deployed end position and a stowed end position. The pivoting and sliding the legrest are by a motor having a single cylinder rigidly attached to the structure and to the frame. A portion of the retraction stroke of the cylinder brings the structure into the stowed position while the extension of the retraction stroke of the cylinder generates the movement of a pulley borne by the rod of the cylinder over which passes a strap which connects the plate to the frame. The movement is suitable for shortening the path of the strap and thus deploying the plate.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to the field of motorized wheelchairs, and

more particularly to a telescopic footrest device.

### 2. Description of Related Art Including Information Disclosed Under 37 CFR 1.97 and 37 CFR 1.98

A wheelchair mainly comprises a rolling frame on which is secured a chair comprising, in addition to a seat, a backrest and armrests, a legrest comprising a plate lined with pads for resting the calves and whose angle is adjustable by being pivotably mounted on the frame, so that the user can find the most comfortable position possible between the two extreme positions, namely legs bent and legs stretched.

On the other hand, the legrest usually has a footrest at its free end, in the form of a substantially perpendicular paddle with an adjustable angle.

Finally, the pads and footrest feature adjustment means to enable the user to find the most comfortable position.

Varying the angle of the legrest relative to the wheelchair poses a problem, in that the pivoting axis of the legrest and that of the user's knee joint are not coaxial, but rather are very eccentric, the pivoting axis of the legrest being located below and behind that of the knee joint.

Thus, for example, when moving from a bent-leg to a stretched-leg position, the distance between the footrest and the axis of the knee joint is reduced, leaving less room for the legs. To overcome this drawback, the plate is slidably mounted on a pivoting structure, so that the distance between the footrest and the knee axis can be adjusted as the angle of inclination changes.

However, the sliding stroke of the plate is not limited to this adaptation, as it is advantageously possible to extend the deployment of the plate until the footrest paddle comes into contact with the ground, in order to facilitate the transfer of the user.

In this way, the footrest/legrest has two functionalities: first, pivoting combined with compensatory extension, and second, extending until it rests on the ground.

The first functionality, which combines two movements, is achieved in a known way by means of an electric cylinder connecting the two pivoting parts, so that inclining in either direction automatically extends or shortens the legrest.

The second functionality consists of a purely rectilinear movement which therefore cannot be performed by the cylinder of the other function, so that this movement is generated, in a manner known per se, by a second cylinder, dedicated to this functionality.

Known footrest devices, which have both these functionalities, are therefore necessarily equipped with two cylinders, namely electric cylinders.

### BRIEF SUMMARY OF THE INVENTION

The purpose of the present invention is to provide a telescopic inclinable footrest device for a motorized wheelchair, which has the two aforementioned functionalities, but requires only a single cylinder for its implementation.

The telescopic inclinable footrest device for a motorized wheelchair according to the invention, wherein said wheelchair comprises a rolling frame on which is secured a chair comprising, in addition to a seat, a backrest and armrests, a legrest consisting of a plate furnished with pads for resting the calves and whose angle is adjustable and whose length is adaptable by being slidably mounted on a structure pivotably mounted on said frame, said plate comprising at its free end a footrest in the form of a paddle whose angle is adjustable, said structure being pivotably mounted between two extreme positions, deployed and stowed, while said legrest is deployable to the ground by movement of said plate when said structure is in a vertical or substantially vertical position, the pivoting of said structure and the sliding of said legrest being provided by motor means, and is characterized in that said motor means consist of a single cylinder that is rigidly attached pivotably both to said structure and to said frame via a pivot eccentric to the pivot axis of said structure on said frame, so that a portion of the retraction stroke of said cylinder brings said structure into a stowed position, while said pivot is able to move on said frame, perpendicularly to its pivoting axis and under the action of an extension of the retraction stroke of said cylinder, said pivot bearing a pulley over which passes a strap or the like which connects said plate to said frame by passing over intermediate angle-reversing pulleys, the movement of said pivot and thus of said pulley being capable of modifying the path of said strap or the like and thus deploying said plate, or vice versa.

An additional feature of the device according to the invention is that it comprises two intermediate return pulleys, one rigidly attached to the pivoting structure close to the pivot axis thereof, the other rigidly attached to the free end of a connecting rod, the other end of which is pivotably mounted on the frame, the strap or the like passing successively, from said frame, over the pulley of said connecting rod and then over the pulley of said structure before being attached to the plate.

According to another additional feature of the device according to the invention, the pivot of the cylinder pulley is translationally movable in a substantially vertically oriented guideway of the frame, the end of which closest to the pivot axis of the structure corresponds to the position allowing the pivoting thereof.

According to another additional feature of the device according to the invention, it comprises means for immobilizing the pivot of the cylinder pulley in the guideway at the level of its end closest to the pivot axis of the structure, during the deployment and stowing operations thereof.

According to another additional feature of the device according to the invention, the means suitable for immobilizing the pivot consist of at least one controlled compression means.

According to another additional feature of the device according to the invention, the controlled compression means consist of a gas-operated cylinder.

### BRIEF DESCRIPTION OF THE SEVERAL VIEWS OF THE DRAWINGS

The advantages and features of the footrest device according to the invention will emerge more clearly from the description which follows and which relates to the appended drawing, which shows one non-limiting embodiment thereof in the appended drawings.

FIG. 1 shows a schematic profile view of a footrest device according to the invention in a horizontally deployed position.

FIG. 2 shows a schematic profile view of the same footrest device while stowing is in progress.

FIG. 3 shows a schematic profile view of the same footrest device in the stowed position.

FIG. 4 shows a schematic profile view of the same footrest device in the position where it is deployed to the ground.

### DETAILED DESCRIPTION OF THE INVENTION

These figures show part 1 of the frame of a motorized wheelchair, not shown, and a footrest device 2 according to the invention, carried by a structure 3 pivotably mounted on the part 1 about a shaft 10, the axis of which is horizontal and transverse to the direction of movement of the wheelchair.

The footrest device 2 comprises a plate 4 slidably mounted on the structure 3 by means of a slide 34, and which comprises on the one hand pads 40, of which only one is visible, intended for the legs to rest on, and more particularly the calves, and on the other hand at its free end, a footrest paddle 41.

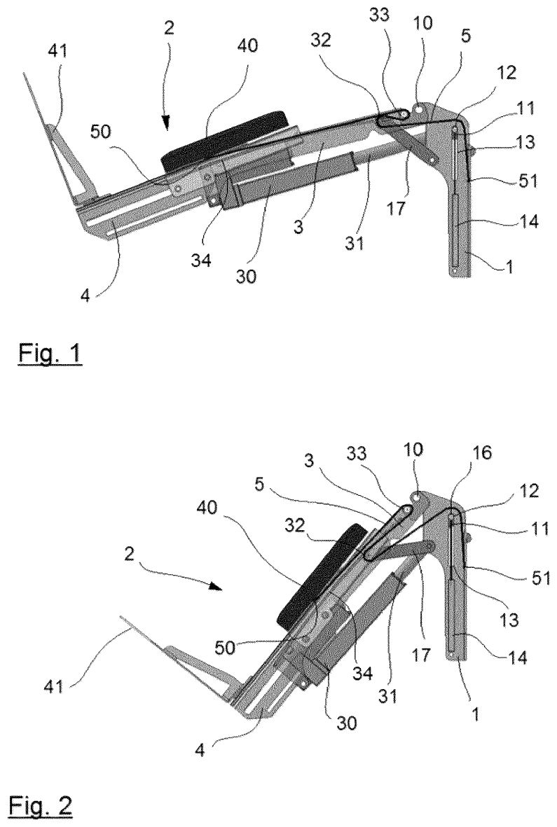

As can be seen from FIGS. 1, 2 and 3, the structure 3 is pivotably mounted to move from a substantially horizontal, deployed position, shown in FIG. 1, to a substantially vertical, stowed position, as shown in the figure.

The structure 3 is pivoted by an cylinder 30, preferably electric, which is pivotably connected to the structure 3, and whose rod 31 is rigidly attached to part 1 of the frame.

The end of rod 31 carries a pulley 11 via a pivot 12 rigidly attached to the part 1 of the frame. The pivot 12, whose axis is parallel to that of shaft 10, is mounted for translational movement in a guide groove 13 that the part 1 comprises, which extends substantially vertically. In fact, that part comprises two parallel grooves 13, only one of which is visible, in each of which an end part 15 of the pivot 12 can move.

It can also be seen that part 1 of the frame features a gas-operated cylinder 14, which pushes and locks the pivot 12 in the upper end 16 of the groove 13, which is eccentric with respect to the axis of the shaft 10.

When the cylinder 3 is fully extended, the structure 3 is in a substantially horizontal extended position, and when the rod 31 is retracted, structure 3 becomes stowed.

To compensate for the fact that the pivot axis of the structure 3 and that of the user's knee joint are not coaxial, the legrest should extend when deployed, and vice versa when stowed, which is achieved by the sliding of the plate 4 on the structure 3.

This sliding in one direction or the other is achieved by shortening or lengthening a strap or the like 5, one end 50 of which is fixed to the moving plate 4, while the other end 51 is fixed to the part 1 of the frame.

It should be noted that, by no means restrictively, a strap is preferentially used.

This shortening or lengthening is achieved as the structure 3 pivots, through the movement of a return pulley 32, which is mounted at the free end of a connecting rod 17, hinged to the part 1 of the frame, and which extends under the structure 3. On the other hand, yjr structure 3 features a return pulley 33 close to the shaft 10.

Thus, the strap 5 passes successively, from the attachment of its end 50 to the moving plate 4, over the return pulley 33, over the return pulley 32 passing under the pivoting structure 3, then over the pulley 11 before being attached to the part 1 of the frame by its end 51.

When the structure 3 pivots, the connecting rod 17 is forced to fold and its idler pulley 32 moves away from the idler pulley 33, lengthening the distance between the ends 50 and 51 of the strap 5 and causing the plate 4 to slide towards the shaft 10. Conversely, when the structure 3 is deployed, the return pulley 32 moves closer to the return pulley 33, shortening the distance between the ends 50 and 51 of the strap 5 and allowing the plate 4 to move away from the shaft 10.

This configuration allows the plate 4 to move as the structure 3 pivots.

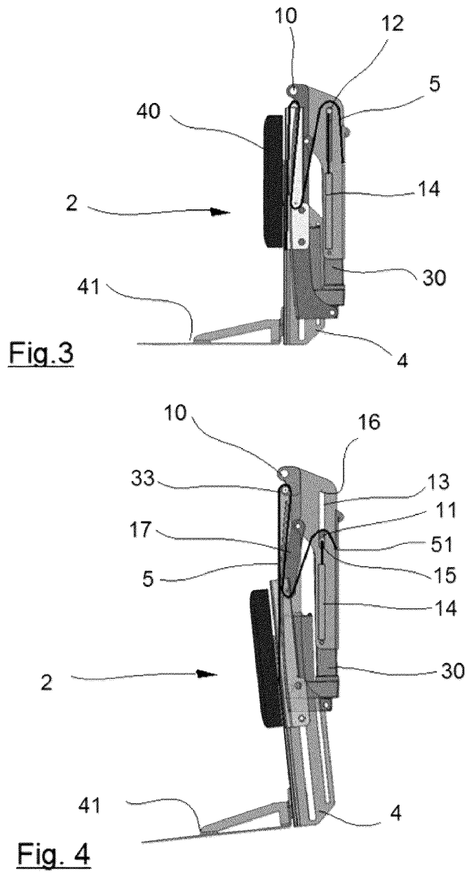

In FIG. 3, structure 3 is in the fully stowed position, the cylinder 30 is in the plane of the groove, and its rod 31 is not fully retracted. Thus, the continued retraction of the rod 31 causes the pivot 12 to slide in the groove 13, compressing the gas-operated cylinder 14, resulting in the movement of the pulley 11 and consequent shortening of the distance between the ends 50 and 51 of the strap 5, without any movement of the connecting rod 17, and thus the sliding of the plate 4 on the structure 3, until the footrest paddle 41 is deployed on the ground by gravity, as shown in FIG. 4.

The use of a gas-operated cylinder 14 is an economical solution, but it is possible to envisage other solutions, such as a compression spring, the essential requirement being to immobilize the pivot 12 at the upper end 16 of the groove 13, during pivoting movements of the structure 3.

In this way, the two functionalities of the footrest according to the invention, i.e. pivoting it with length adjustability, and deployment to the ground, are ensured by means of a single cylinder.

I claim:

1. A telescopic inclinable footrest device for a motorized wheelchair having a seat, a backrest and armrests, the footrest device comprising:
a rolling frame;
a structure pivotally mounted on the frame; and
a legrest being comprised of a plate furnished with pads having an adjustable angle and an adaptable length slidably mounted on said structure,
wherein said plate comprises a footrest at a free end, said foot rest being comprised of a paddle whose angle is adjustable, said structure being pivotably mounted between two extreme positions, deployed and stowed, while said legrest is deployable to the ground by movement of said plate when said structure is in a vertical position, the pivoting of said structure and the sliding of said legrest being provided by motor means,
wherein said motor means comprises a single cylinder rigidly attached pivotably both to said structure and to said frame via a pivot eccentric to the pivot axis of said structure on said frame, and
wherein a portion of the retraction stroke of said cylinder brings said structure into a stowed position, while said pivot is able to move on said frame, perpendicularly to its pivoting axis and under the action of an extension of the retraction stroke of said cylinder, said pivot bearing a pulley over which passes a strap which connects said plate to said frame by passing over intermediate angle-reversing pulleys, the movement of said pivot and said pulley modifying a path of said strap and deploying said plate, or vice versa.

2. The footrest device, according to claim 1, further comprising: two intermediate return pulleys, one rigidly attached to the pivoting structure close to the pivot axis thereof, the other rigidly attached to the free end of a connecting rod, the other end of which is pivotably mounted on the frame, the strap passing successively, from said frame, over the pulley of said connecting rod and then over the pulley of said structure before being attached to the plate.

3. The footrest device, according to claim 1, wherein the pivot of the pulley of the cylinder is translationally movable in a vertically oriented guideway of the frame, whose end closest to the pivot axis of the structure corresponds to the position allowing the pivoting thereof.

4. The footrest device, according to claim 3, further comprising: means for immobilizing the pivot of the pulley of the cylinder in the guideway at its end closest to the pivot axis of the structure, during the deployment and stowing operations thereof.

5. The footrest device, according to claim 4, wherein the means for immobilizing the pivot is comprised of at least one controlled-compression means.

6. The footrest device, according to claim 5, wherein the controlled-compression means is comprised of a gas-operated cylinder.
